(19) United States
(12) Patent Application Publication
(10) Pub. No.: US 2005/0203801 A1
(43) Pub. Date: Sep. 15, 2005

(54) Method and system for collecting, sharing and tracking user or group associates content via a communications network

(76) Inventors: Jared Morgenstern, Aliso Viejo, CA (US); Edward Lim, Aliso Viejo, CA (US)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/045,164

(22) Filed: Jan. 27, 2005

Related U.S. Application Data
(63) Continuation-in-part of application No. 10/997,121, filed on Nov. 24, 2004.
(60) Provisional application No. 60/525,905, filed on Nov. 26, 2003.
(60) Provisional application No. 60/481,957, filed on Jan. 27, 2004.
(60) Provisional application No. 60/481,955, filed on Jan. 26, 2004.

(51) Int. Cl. G06F 17/60; G06F 15/16

(52) U.S. Cl. 705/14

(57) ABSTRACT

A content collection, sharing, and tracking method and system allows individuals or groups to incorporate the content of one another into their own context for creative referenced re-use. Users browse the content of other users and add content to a tool known as a GRAB BAG. Users may be part of affinity groups such as social networks or have common interests such as an interest in a single Internet auction site. The GRAB BAG storage system keeps track subsequent revisions and contexts for the piece of content in all instances where it is grabbed. When users incorporate the content they have grabbed into their own content, it appears with a link to the original author as well as with links to track the dissemination of the original content. The GRAB BAG storage system is created to reference content so that identical items under two different contexts need not be duplicated in full.

### CROSS REFERENCE TO RELATED APPLICATION

Priority is claimed to U.S. Provisional Patent Application Ser. No. 60/481,957, filed Jan. 27, 2004, the contents and program listing of which are incorporated herein by reference. This application is a continuation-in-part of U.S. patent application Ser. No. 10/997,121, filed Nov. 24, 2004, which has priority to Provisional Application Ser. No. 60/525,905, filed Nov. 26, 2003, the contents of both of which are incorporated herein by reference.

### BACKGROUND OF THE INVENTION

1. Field of the Invention

The present invention relates to a system and method of collecting, revising, organizing and storing data concerning an online community.

2. Description of the Related Art

A widely used model for organizing and implementing purchases online is use of a shopping cart analog. Such electronic commerce typically involves users browsing web sites and, when they see items that they want to purchase, adding the items to the shopping cart (phase 1 of purchasing). When they have added all their items, users typically enter a check-out phase (phase 2 of purchasing) that allows the users to confirm the items in their shopping cart and specify or modify shipping and payment information. In another shopping model, online commerce websites have pre-stored purchase and delivery information for some users, and once the users have selected and approved items for purchase, the order is completed. A more recent phenomenon is the usage of online social networking systems that allow people to exist in communities and publish content to the web or associated content with themselves. There have also been approaches that allow groups to browse the web together and shop together by sharing reviews and other preferences. One way to accomplish this includes linking to content in known systems, such as a hyperlink to the associated content of friends, or a user could re-create the content and provide a message saying where the content originated, etc. One deficiency of the known methodology is that user input and linking is required, making it relatively difficult for a user to share and make available shopping or product information.

One known linking methodology applied to creative processes has been developed by Creative Commons (creativecommons.org), which provides licenses for creation of derivative works (new creative works based pre-existing works), which allows users to share their creativity. Although this promotes sharing in the creative process, it suffers the deficiency that it fails to provide a way of sharing in product or service shopping, or in sharing preferences pertaining to media such as music, video, shows, etc.

Accordingly, there exists a need for a system and method of sharing and passing on of content, such as art or music reviews, and product preferences, while giving credit to the original author and providing a reference to the original form created by the author.

A known means for content referencing has been through the use of external or internal hyperlinking. This method suffers a disadvantage of not allowing content to be present with the user or group who is advocating it, and requires clicking a link for access. Accordingly there also exists a need for an automated system of providing users with the ability to incorporate and reference other user or group content into their own content collections. There further is a need for a system providing improved access to incentives for content creators to allow their content to be collected in such a manner.

There also is a need for a system and method of collecting, sharing, and tracking user or group associated activity via a communications network that enables users to easily incorporate other users' content into their own content—whether related to products, services, reviews or any form of content a user may wish to associate with herself or himself.

### SUMMARY OF THE INVENTION

The present invention alleviates to a great extent the disadvantages of known advertising and content evaluation systems by providing an automated mechanism where brand owners can tap into a network of individuals or groups who are willing to represent their brands via their identities as part of a community.

In some embodiments, the present invention involves using a tool referred to as a GRAB BAG to collect the content or associated content of individuals or groups and associate it with a particular user. In this embodiment, individuals or groups agree to allow such content to be collected in exchange for a service, as part of an online service, or for some reward, monetary or otherwise. Once grabbed, the content can be referenced from the grabbers' content or even purchased via traditional shopping cart functionality, which in one embodiment would have an associated reward for the owner of the original associated content. In one implementation, it also provides a way for the original content owner to track the dissemination of his/her material.

In one aspect of the invention, a framework of collecting and sharing images in an online gallery is provided. In this aspect, users optionally are connected via their real life relationships to one another. For example, a user may browse a friend's (such as for hypothetical example, Mike's) galleries. The user can add to his/her GRAB BAG all the images that Mike has in his gallery. The user can access another friend's (such as for hypothetical example, Melissa's) content and add an image of a mutual friend that the user finds in one of her galleries to the user's GRAB BAG. Once in the GRAB BAG, the user may convert the image to a gallery of his/her own (optionally referencing Melissa and Mike) for people who visit the user's galleries (which may be a different audience) to view. It should be noted that “friend” is used herein to mean any associated individual or group and does not require there to be a personal relationship outside the context of the referencing discussed herein. Alternatively, the user may wish to print these images in his/her GRAB BAG via a partnered picture printing service company. In either case, Mike and Melissa may receive a reward of some kind. In one example, the reward would be a percentage of the image printing profit or the advertisements that are associated with the pages when their pictures are present, although other forms of rewards also may be provided. Mike and Melissa could also take advantage of an interface that informed them about who had collected their content. One benefit to this method is that the content need not be duplicated. It can exist once in storage and be referenced by more than one individual. For example, if there is video that is being referenced on Jack's web page and on Jill's web page, but it is John's original content collected from John's page, the video need only be stored once, even if there are three distinct references to it.

In another embodiment, if Mike is part of a system that allows him to associate his online presence with an advertisement or brand and a user browses his content and views the brand that he/she is supporting, the user may add the brand to his/her GRAB BAG. This implicitly associates the user with the content, in this case a brand.

By providing such a framework, the current invention provides an incentive for users to share and create valuable content to such online communities, provides an storage efficient way for creating rich content collections for a multiplicity of users, and allows an easy mechanism for viewers to incorporate, find, manage, and bookmark content that they like. It also provides an efficient method for spreading content across networked individuals rapidly. This invention is particularly useful in conjunction with a system such as described in U.S. patent application Ser. No. 10/997,121, filed Nov. 24, 2004 and Provisional Application Ser. No. 60/525,905, which are incorporated herein by reference.

Further examples of advantages of the present invention include an easy to use interface and system whereby a user can quickly and efficiently collect and incorporate associated content that they view or browse into their own content displays; a content creator or associated content agent can determine which pieces of content can be collected via such a system, as well as monitor the usages of this content; and users can relatively easily collect content they are browsing for referenced inclusion in their content or for purchase.

In one aspect of the invention, a method of managing content is provided comprising receiving a request in a server system from a viewer to access content associated with a user or group of users, presenting the content to the viewer, receiving a content association request from the viewer relating to requested content, and adding the requested content to content associated with the viewer. The content association request can include a content identifier associated with the requested content, and the server can retrieve the content using the content identifier. The server can also perform a determination procedure to determine whether the viewer is authorized to collect the requested content. Furthermore, the server can determine the viewer's proposed use of the requested content and determine if the proposed use of the requested content complies with one or more previously specified use criteria for the requested content, such as specified by the user or author. The use criteria can be selected from a group consisting of creative common licenses, distribution, modification, and attribution. The content can includes digital content data that optionally includes product purchasing information. A reward can be provided to users whose content is retrieved or whose content leads to a purchase by other users or viewers. In a further aspect of the invention, the viewer is required to pay to retrieve content. In another aspect of the invention, the user can post comments on the content and contribute to the requested content.

### BRIEF DESCRIPTION OF THE DRAWINGS

These and other features of the invention, its nature, and various advantages will be appreciated from the accompanying drawings, and the following detailed description in which like reference numbers represent like parts throughout:

FIG. 1 is a block diagram of a method and system for collecting, sharing, and tracking content via a communications network, in accordance with a preferred embodiment of the present invention referred to as a GRAB BAG system;

FIG. 2 is a flow chart depicting the high level functionality of the GRAB BAG system via a communications network;

FIG. 3 is a flow chart showing the client-server functionality from when content is GRABBED to how it may be stored in the database;

FIG. 4 is a block diagram of a viewer client for the GRAB BAG system;

FIGS. 5 and 6 show a database schema for a preferred embodiment of the invention (as shown by metails.com and which the attached program listing interacts with);

FIG. 7 is an illustration of an example add to GRAB BAG client display; and,

FIG. 8 is an illustration of an example incorporate GRABBED content client display.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. It will be apparent that the invention can be embodied in a wide variety of forms, some of which may be quite different from those of the disclosed embodiments. Consequently, the specific structural and functional details disclosed herein are merely representative and do not limit the scope of the invention. As used herein, the “present invention” refers to any one of the embodiments of the invention described herein, and any equivalents. Furthermore, reference to various aspects of the invention throughout this document does not mean that all claimed embodiments or methods must include the referenced aspects.

Generally speaking, a method of collecting, sharing, and tracking user or group associated content is provided in which the method includes the steps of: under control of a client system (“client” as used herein is also referred to as a “viewer”), displaying information identifying individuals or groups of individuals (also referred to as “users”) and their associated content; in response to an action being performed, indicating a desire to collect the content relating to the individual or group of individuals, sending a request to collect the requested content along with an identifier of the content requested; and under control of a server system, receiving the request from the client or viewer, retrieving additional information regarding the associated content, using the identifier in the received request, and adding the associated content to the requestor's associated content. It should be noted that all or a portion of these steps may be practiced in realization of the present invention.

In one embodiment of the above described GRAB BAG framework, individuals or groups (i.e. particular users) can specify who can collect their content and how it can be used. In another embodiment, collected content may be restricted in its use by the collector (or user) as facilitated by the technology (such as by the restrictions of various Creative Commons licenses: distribution [yes/no], modification [yes/no], attribution [yes/no]). In a further embodiment, the authoring individual or group can withdraw all instances or derived instances of content. Alternatively, another embodiment may allow the authoring individual or group to only withdraw the original instance of the content. In another embodiment, a GRAB BAG system allows individuals or groups, whether original or derivative authors, to view and manage the dissemination of their associated content. Instances of this invention could exists within a closed community, such as a social network. The GRAB BAG framework is meant to facilitate the sharing and collection of digital pictures, text, video, music, any other media, or advertisements.

An embodiment of the invention utilizes the GRAB BAG framework as a revenue model and/or to facilitate transactions between agents. In one example, associated content original or derivative authors are rewarded when individuals or groups (other users or viewers) collect their content. In another example, the rewards are privileges offered by a website, such as reward points, gift certificates, or extra quota space. In yet a further example, it allows associated content original or derivative authors to accept rewards (points, money) from requesters in order to allow their content to be collected. In another example, requestors trade content or rewards in order to collect content. Requestors may be required to pay in order to collect content. Such payments may take the form of payment to either the author or derivative author according to the size and type of content they collect (i.e. pay per file size of an image) while the service provider takes a percentage (which may be zero (0)). In a preferred embodiment, requestors are rewarded for collecting content (advertising images) and original authors are rewarded when people print pictures that they have uploaded. This could be extended to a system where requestors are rewarded by the service providing site (i.e. extra quota, gift certificates, reward points). In another aspect of the invention, a method of efficiently storing collected content in which the content is stored as a delta (or change) from its parent (i.e. an image collected an unmodified does not need to be stored twice), creates hierarchical trees of derivative work for efficient storage. A preferred embodiment of the invention also promotes or requires collectors to post comments or contribute to the content in order to collect it, facilitating a forum about the associated content. It should be noted that “content” as used herein can optionally encompass and refer to product descriptions or product purchase pages or links and the rewards associated with content can be granted based on purchases made by other users or viewers who click on or otherwise view the content or associated or linked webpages and purchase products or services. For example, the reward can be a percentage of a purchase price or a referral fee. Likewise, the “content” can optionally encompass and refer to advertisements and rewards based on the content can be based on any model, for example pay-per-click. In another example, the “content” can optionally refer to pay-per-view content or fee-for-view or fee for download content.

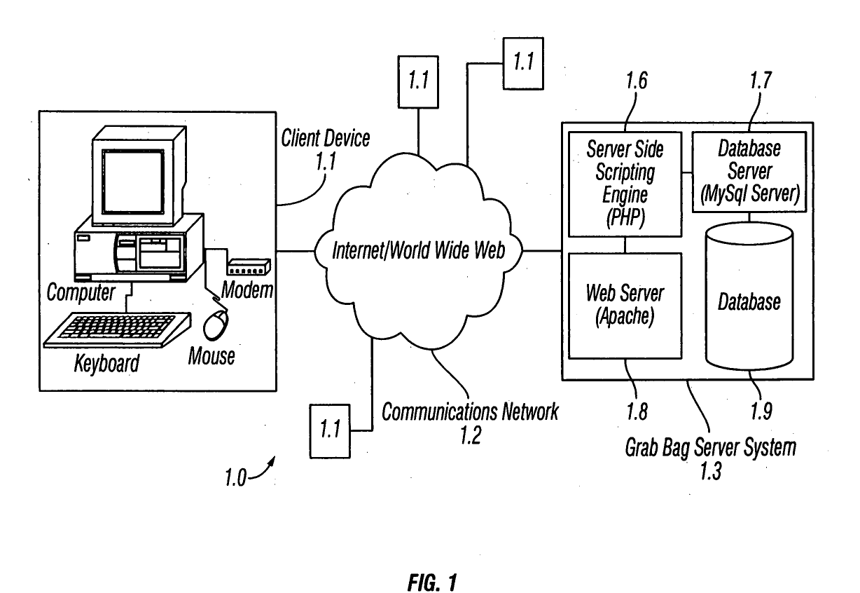

Referring to FIG. 1, there is generally shown a method and system for collecting, sharing, and tracking user or group associated content via a communications network in accordance with the present invention (also referred to as a GRAB BAG system). The GRAB BAG system 1.0 includes a plurality of client devices 1.1 (such as may be accessed by the “users” or “viewers” discussed herein), each of which is coupled to a network 1.2 and, in turn, to a GRAB BAG server system (GBSS) 1.3. Each client device 1.1, of which one is shown in some detail and three others are represented in block form, is typically a personal computer, such as a Windows-based personal computer. It should be understood that client devices may also be laptops, PDA's, workstations, mobile phones, Internet enabled TV, etc. Each client device 1.1 preferably has an input device such as a keyboard and/or mouse and a display for communication with a user. The client device 1.1 preferably has communications software and a modem (or some other form of Internet connectivity, such as a DSL modem, cable modem, T-1 line, ISDN line, etc.). Communications software may be any software suitable for telecommunications, and is preferably browser software. The communications software is for communication over network 1.2 with a GBSS 1.3. Network 1.2 may be, for example, the Internet.

The GBSS 1.3 is preferably a web application that displays contents authored by agents, where agents are individuals or groups and also optionally may include the users and viewers discussed herein. The GBSS 1.3 may be a wholly integrated web application, such as a web log and social networking web site, that allows users to decorate themselves with brands and shares the same web server 1.8, database provider, and server side scripts. It should be understood that the GBSS 1.3 may be utilized by third party web applications. Examples of third party web applications include Blogger, social networking systems such as Friendster, instant messaging systems such as AOL Instant Messenger, and community oriented applications such as Ebay, and oPhoto, provided these services are modified to interface with the GBSS 1.3.

The GBSS 1.3 typically includes, for example, a web server, which is characteristically a programmed computer, preferably one that supports a HyperText Transfer Protocol (HTTP), that handles document requests and provides other services, returning information to the requester. It should be understood that the web server may communicate by exposing web services which communicate XML, etc. It should be clear that the web server could be replaced by an application that functions as a server, such as a program that listens to a specific port for incoming request. Many suitable software programs for the web server exist, including Apache and “MICROSOFT” Internet Information Services (IIS). GBSS 1.3, in addition to a web server, includes a server side scripting engine 1.6, preferably PHP, available from php.net, connected to the web server for pre-processing an output from the web server before it is returned via the communications network. The server side scripting engine 1.6 also allows communication with a database server 1.7, preferably Mysql, available from mysql.com, using the Open Database Connectivity (ODBC) protocol. Other similar server side scripting products could be used, such as Cold Fusion, ASP.NET technology. The database server 1.7 is generally configured as an SQL database, and, besides Mysql, other database systems could be used such as those available from Oracle, Informix, “MICROSOFT”, or Sybase. The GBSS 1.3 may also be a multi-server system, such as a web farm. The database server 1.7 is in communication with a database 1.9 in which the database server 1.7 stores content.

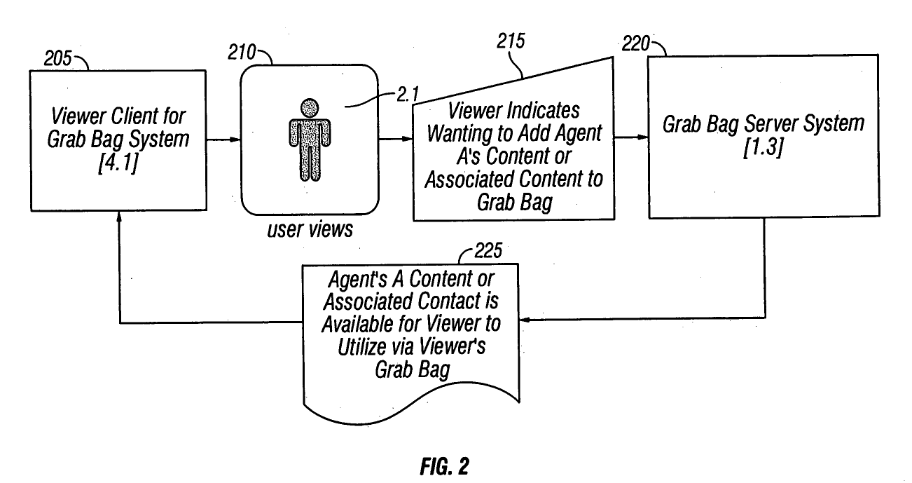

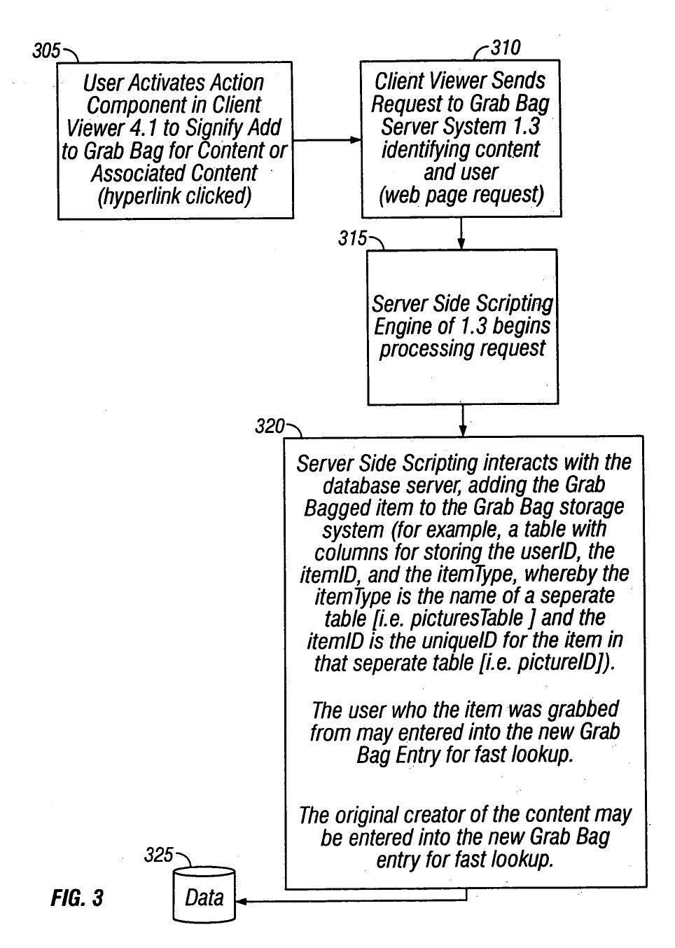

Referring to FIG. 2, there is generally shown the high level flow by which a viewer 2.1 may add a piece of content to their GRAB BAG store in a GBSS 1.3. It should be noted that “viewer” as used herein is a “user” who is viewing another user's content. At other times or simultaneously a “viewer” can be making his/her own content available to viewing by other viewers. A preferred example of this flow involves a viewer 2.1 viewing content in a web browser as illustrated with reference number 205, the web browser also referred to more generally as a viewer client for Grab Bag system 4.1. The web browser acts as the Viewer Client 4.1, which displays content of a particular user and an option to grab their picture (210), for example. The user may indicate wanting to add another user's (for example Agent A's) content or associated content to his grab bag (215). In other words, a request is sent from the viewer's system to the grab bag server system (GBBS 1.3) (220). The GBSS 1.3 processes the request in any desired fashion, such as first receiving it from the web server, processing the appropriate PHP, accessing the Mysql database when necessary, and entering what is necessary in the database to store the association between the instance of the content where it was grabbed, the original instance, and the new instance where it is being grabbed to. The user's (Agent A's) content or associated content is then made available to the viewer to utilize via the viewer's GRAB BAG (225).

FIG. 3 is an example of possible process steps relating to the client-server interaction. A user (i.e. viewer 2.1) activates an action component in the client viewer 4.1 to initiate an adding of selected content to the user's GRAB BAG (305). According to one embodiment, this may be done, for example, by the user selecting a hypertext link such as by clicking or using any other input device, such as a mouse, keyboard, voice recognition software, touch-screen, light pen, etc. The client viewer 4.1 sends a request to the GRAB BAG server system 1.3 (310). In one embodiment, the request contains an identifier or plural identifiers indicating the content the user desires to grab and identifying the particular viewer 2.1 making the request (310). After receiving the request, the server system 1.3 begins processing it, such as using the server side scripting engine 1.6 (315). In this example, the server side scripting engine 1.6 optionally interacts with a database 325 (such as on the database server 1.7) to retrieve the content (320). The grabbed content is then stored in the user's (i.e. viewer 2.1) GRAB BAG. In other words, the grabbed item is added by the server system 1.3 into a grab bag storage system (such as in a storage unit such as database system 1.9) (320). The grab bag storage system for example includes a data structure, such as for example a table with columns for storing a userID identifying the viewer 2.1 grabbing the content, an itemID identifying the content grabbed and an itemType indicating the type of content (320). The itemType can optionally be the name of a separate table (i.e. a pictures table) (320). The itemID can be a unique identifier (i.e. uniqueID) for the item in that separate table (i.e. a pictureID) (320). Other records also can be retained relating to other pertinent information, such as regarding the user (i.e. viewer) who requested (i.e. grabbed) the content, the user whose content was grabbed, date and time information regarding the request, and possibly other information (320), such as in a fast lookup table. The original creator of the grabbed content also may be recorded (320).

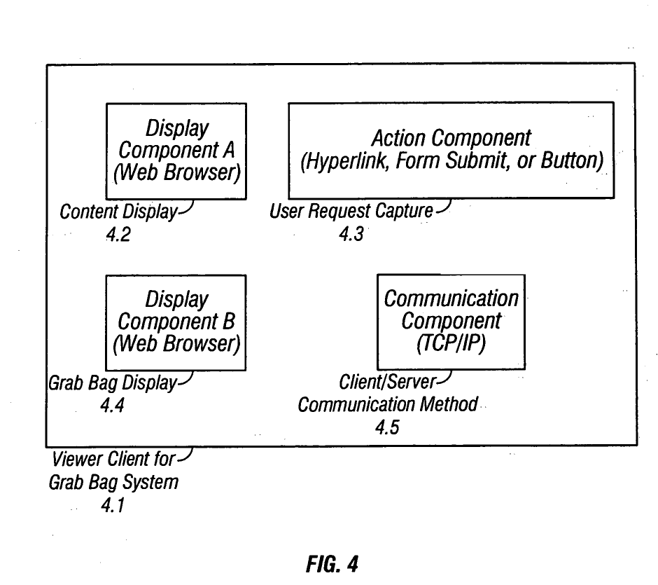

FIG. 4 depicts the typical components required for a Viewer Client for a GRAB BAG System 4.1. There are displays for two types of information, content 4.2 and collect requests 4.3. It should be apparent that these two types of displays may be rendered by the client 4.1 in the same display, as a web browser does. For example the displays may be in different parts of the same window, different parts of a display screen, simultaneous, in separate windows etc. In one example, they may be in separate windows such as in a client application that separates advertisement display from content display, such as Kazaa Media Desktop, AOL Instant Messenger, or the iTunes Software Application. An action component 4.3 (such as a hyperlink, form submit, button, etc.) is activated by the viewer 4.1 to indicate a desire for an agent's content. This is typically assisted via the methods (also commonly known as input techniques or devices) that a web browser supports for interaction, such as keyboard input, mouse input, etc., but extends to other methods of interaction such as the utterance of a sound or the touching of a screen or the sending of an electronic mail message. Finally the GRAB BAG System 4.1 requires a method for communication with a server system 4.5, typically this is TCP/IP used by the web browser.

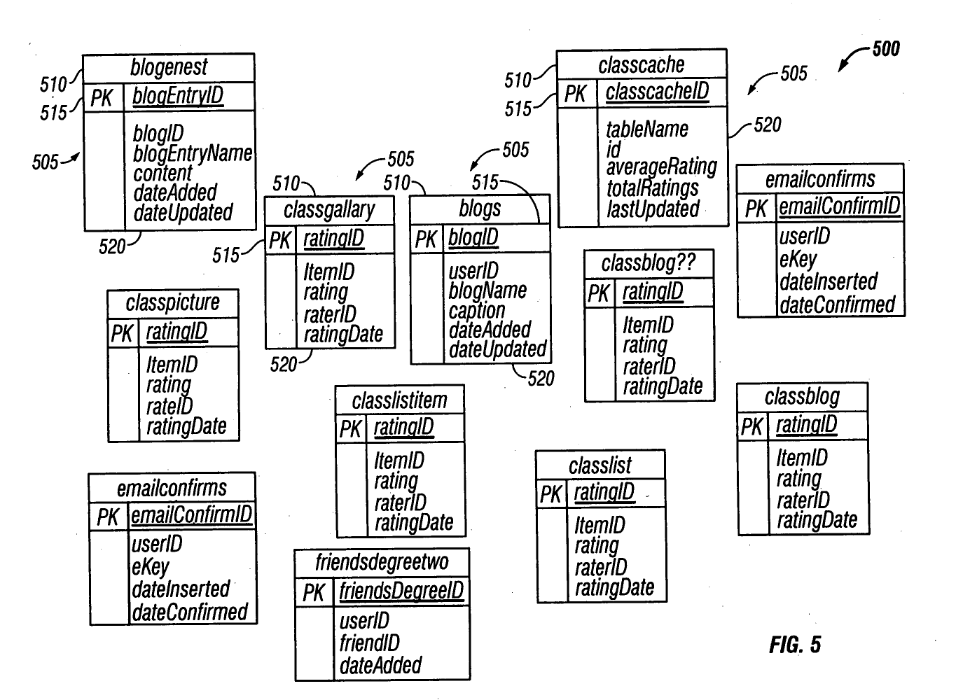

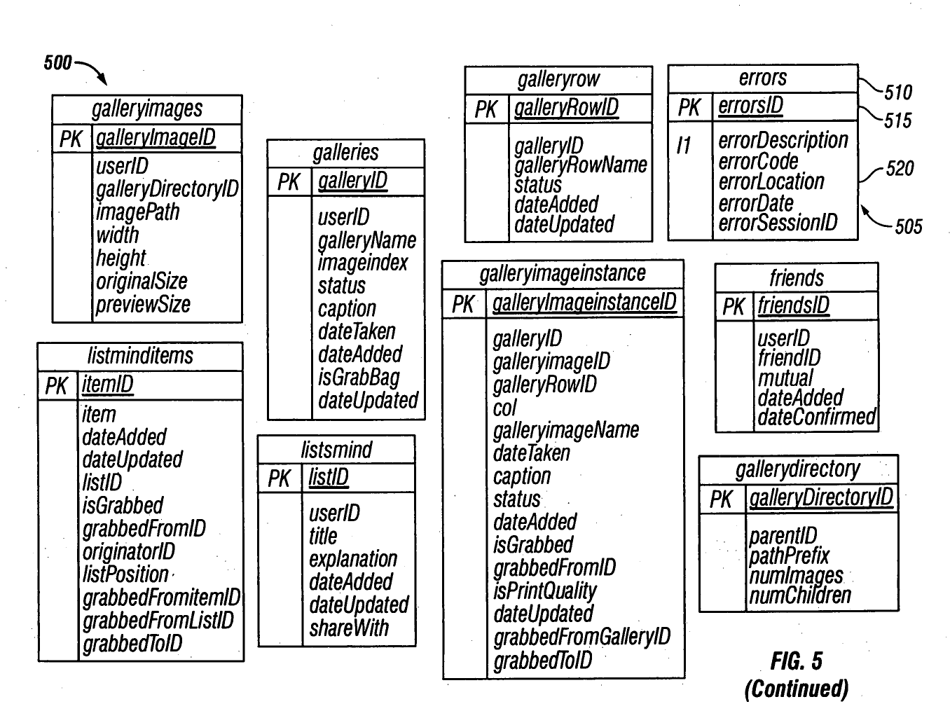

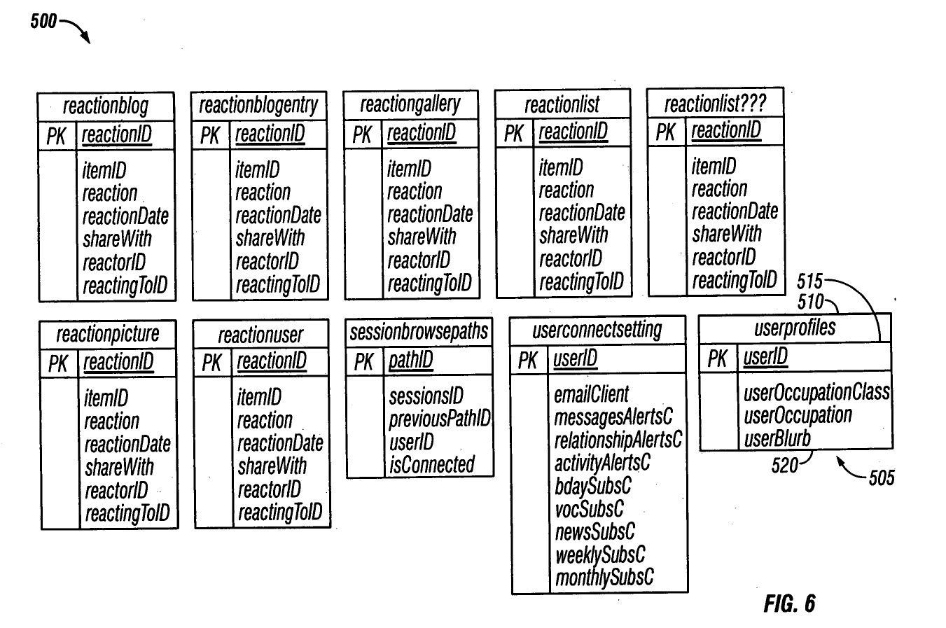

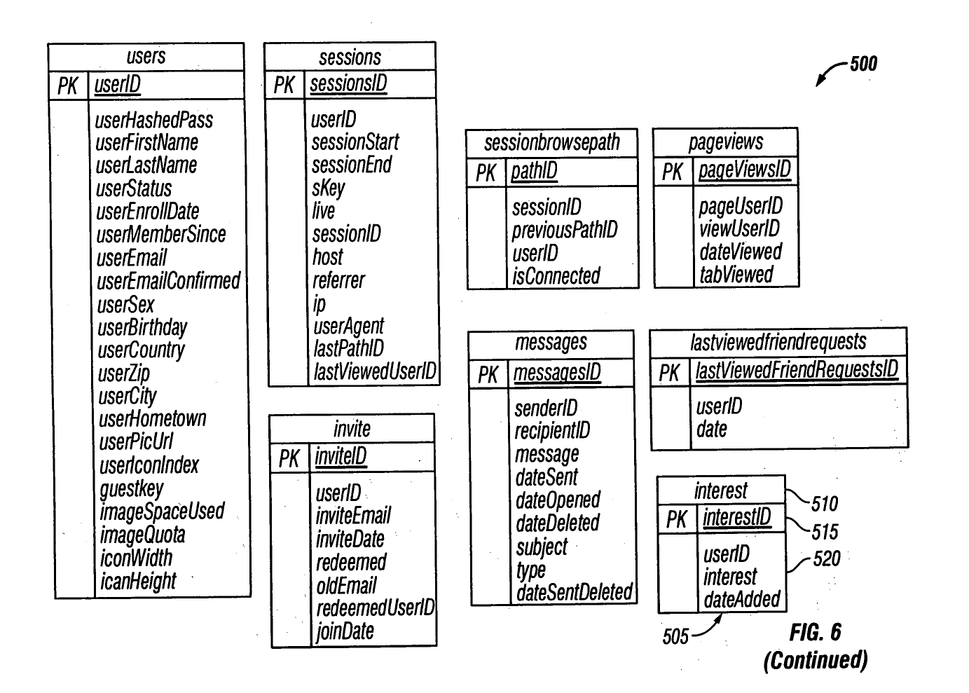

FIGS. 5 and 6 illustrate database schema 500 for a plurality of data objects 505. The data objects 505 may include objects relating to, for example, blog entries, blogs, class gallery, class cache, class blog entry, class picture, class list item, class list, class blog, electronic mail confirmations, friends, second degree friends, gallery rows, gallery images, galleries, gallery image instances, gallery directories, errors, lists mind, list mind items, reaction blogs, reaction blog entry, reaction gallery, reaction list, reaction list item, reaction picture, reaction user, session browse paths, sessions, user contact settings, user profiles, users, page views, messages, invites, interests, and last viewed friend requests.

Each data object 505 may include a data object name 510, data object identifier 515, and data object information 520. The data object name 510 may be a name assigned by a programmer, administrator or other user of a system for constructing a networking database and system proactively. The data object identifier 515 may be an identifier that is used by the system for retrieving that data object. The data object information 520 may include information relating to that data object 505. For example, an errors data object 505 may include a data object name 510 titled errors. The data object identifier 515 may be titled errorsID. The data object information 520 may be information relating to errors encountered while the system is being used. For example, the data object information 520 for an errors data object 505 may include an error description, code, location, date, and sessionID. This information assists a programmer, administrator or other user in determining how to correct the error.

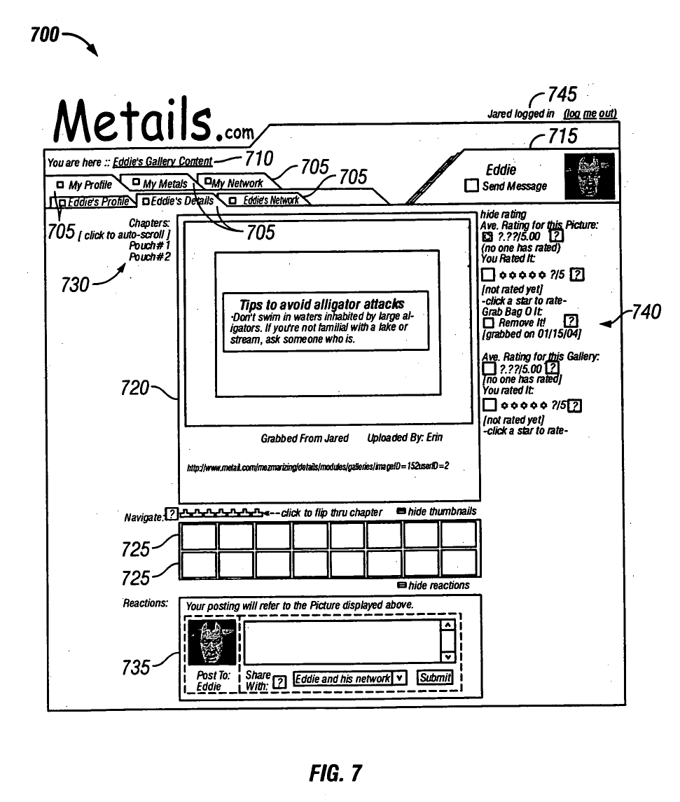

FIG. 7 is an exemplary illustration of screenshot 700 showing how content may be GRABBED. The web page 700 may include one or more selectable operations, such for example via tabs 705 as illustrated or any other means. The option selector icons 705 may be selected using, for example, a convention keyboard, mouse, touch-screen, voice recognition software, etc. The web page 700 may also include a web page identifier 710 that identifies the viewer or the viewer's page being viewed. The web page 700 may include a preview pane 720 that presents a preview of an item located in a user's pouch 725. For example, if an item in at least one of the pouches 725 is selected, that item is displayed in the preview pane 720. The item may be, for example, an image, text, video, audio etc. The viewer 2.1 may examine the item in the preview pane 720 to determine whether to grab that item and add the item to the viewer's content. The item may be grabbed and added to the viewer's content by, for example, clicking and dragging the item to the tab 705 labeled “My Metails” or via any other action sufficient to send a grab request to a server. The viewer may then drop the item into the viewer's content using known or desired techniques. Alternatively, the viewer may select an icon, such as the “Grab Bag® It” icon displayed in a ratings field section (described in further detail below) of the web page 700.

Each pouch 725 may be, for example, a subset of the user's content. The pouches 725 may hold a predetermined number, for example, eight (8), of items, or may be expandable or contractible to any number of content items. In one embodiment, a pouch is of limited size, and when a predetermined number of items in the pouch has been reached, an additional pouch 725 may be created. The items in each pouch 725 may be displayed as thumbnails. In one embodiment, a particular pouch 725 may be selected using pouch selectors 730. In one alternative embodiment, a limited number of pouches 725 are displayed on a web page 700 and if a viewer desires to see items in a pouch 725 that is not displayed, the viewer may select another pouch using the pouch selectors 730.

A message field 735 may also be included in the web page 700. The message field 735 enables the viewer to post a message to the user whose content is being viewed. The message field 735 may enable the viewer to share the message with only the user, the user and his network or possibly other options.

The web page 700 may also include a ratings field 740. The ratings field 740 may provide ratings for particular content associated with a user. The ratings shown may be average ratings for a particular item, the viewer's rating for the item, average rating for the user's particular content, such as a gallery of items, the viewer's rating for the gallery, etc.

A connection field 745 may be provided to indicate whether the viewer is logged-in. If the viewer is logged-in, the connection field 745 may include a log-out option. If the viewer is not logged-in, the connection field 745 may include a log-in option.

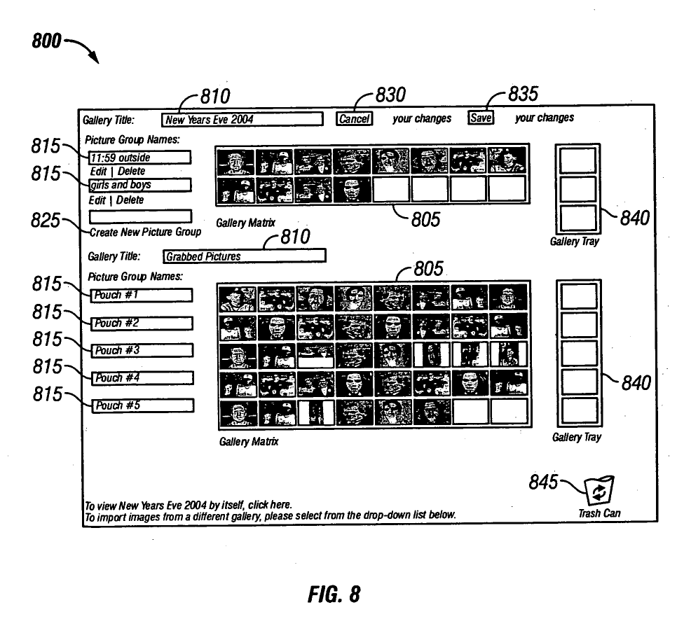

FIG. 8 is an illustration one example of a web page illustrating how grabbed content optionally may be incorporated after being GRABBED. In this example, illustrated web page 800 is presented to a viewer upon grabbing another user's content and adding that content to the viewer's content. The web page 800 may include one or more matrices 805 that displays items in a content gallery such as via viewable or hearable thumbnails. A gallery title 810 may be used to identify the galleries that are being viewed. Each gallery may include one or more pouches 815 (described above). Modifying functions 820 may be displayed that enable the viewer to edit and/or delete one or more items in the gallery when selected. A “Create New Picture Gallery” option 825 may also be presented. The “Create New Picture Gallery” option 825 enables the viewer to create a new picture gallery with content. The content may include previously grabbed content, newly grabbed content, uploaded content or other content.

Gallery options may also be displayed. The gallery options may include, for example, cancel option 830 and save option 835. The cancel option 830 enables the viewer to cancel any modifications made to a gallery before the modifications have been saved. The save option 835 enables the viewer to save any modifications made to a gallery.

A gallery tray 840 may also be associated with a gallery. The gallery tray 840 may be used to store items desired to be saved by the viewer but not desired to be available to other users. For example, a viewer may upload a picture to his/her content, however, the viewer does not desire that other users be able to view the picture until a later date. The viewer may simply place the picture in the gallery tray 840 associated with a desired gallery. When the viewer desires the picture be made available to other users for viewing, the viewer may move the picture from the gallery tray 840 to a desired pouch. If, however, the viewer decides that he/she does not wish one or more particular items to be viewed by other users, the viewer may move the particular items to the trash can 845 using known techniques.

Thus, it is seen that a method and system of collecting, sharing, and tracking user or group associated activity via a communications network is provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

1. A method of managing content comprising:
receiving a request from a viewer to access content associated with a user or group of users;
presenting the content to the viewer;
receiving a content association request from the viewer relating to requested content; and,
adding the requested content to content associated with the viewer.

2. The method of claim 1 wherein:
the content association request includes a content identifier associated with the requested content; and
retrieving content using the content identifier.

3. The method of claim 1 further comprising determining if the viewer is authorized to collect the requested content.

4. The method of claim 1 further comprising determining the viewer's proposed use of the requested content and determining if the proposed use of the requested content complies with one or more previously specified use criteria for the requested content.

5. The method of claim 4, wherein the use criteria are selected from a group consisting of creative common licenses, distribution, modification, and attribution.

6. The method of claim 1 further comprising withdrawing all instances of the requested content.

7. The method of claim 1 wherein the associated content includes digital content data.

8. The method of claim 7 wherein the digital content data includes product purchasing information.

9. The method of claim 1 further comprising providing a reward to the user whose content is retrieved.

10. The method of claim 1 further comprising providing a reward to the user if another user or a viewer makes a purchase of a product or service associated with the user's content.

11. The method of claim 1 further comprising requiring the viewer to trade at least one of content and rewards to retrieve content.

12. The method of claim 1 wherein the viewer is required to pay to retrieve content.

13. The method of claim 1 wherein the user is rewarded by a service providing web site.

14. The method of claim 1 wherein collected content is stored as a change from its parent.

15. The method of claim 1 where the user is required to at least one of post comments and contribute to the requested content to collect the associated content.

16. A system of managing content comprising:
a request receiving module receiving a request from a viewer to access content associated with a user or group of users;
a presenting module presenting content to the viewer;
a content association request module receiving a content association request from the viewer relating to requested content; and,
a content association module adding the requested content to content associated with the viewer.

17. The system of claim 1 wherein:
the content association request includes a content identifier associated with the requested content; and
retrieving content using the content identifier.

18. The system of claim 1 further comprising determining if the viewer is authorized to collect the requested content.

19. A method of managing content, the method comprising:
requesting access to content associated with a user or group of users;
receiving the content; and,
making a content association request to associate requested content with a viewer.

20. The method of claim 19 wherein the content association request includes a content identifier associated with the requested content.
